(19) United States
(12) Patent Application Publication
(10) Pub. No.: US 2022/0386424 A1
(43) Pub. Date: Dec. 1, 2022

(54) ELECTRIC RANGE AND METHOD FOR CONTROLLING ELECTRIC RANGE

(71) Applicant: LG ELECTRONICS INC., Seoul (KR)

(72) Inventors: Ji Won LEE, Seoul (KR); Junghyeon CHO, Seoul (KR); Myoeng Soo PARK, Seoul (KR)

(21) Appl. No.: 17/827,031

(22) Filed: May 27, 2022

(30) Foreign Application Priority Data
May 28, 2021 (KR) 10-2021-0069180

(51) Int. Cl. H05B 6/06; F24C 7/06; H05B 6/12

(52) U.S. Cl. CPC H05B 6/062; F24C 7/067; H05B 6/1245; H05B 2213/07

(57) ABSTRACT

An electric range and a method for controlling an electric range are provided, in which a plate temperature sensor configured to sense a temperature of a cover plate and a thermal fuse configured to sense overheating of the cover plate are connected in series to configure a temperature sensing circuit, thereby simplifying a control substrate to which the temperature sensing circuit is electrically connected and reducing manufacture costs.

### CROSS-REFERENCE TO RELATED APPLICATION(S)

This application claims priority to and the benefit of Korean Patent Application No. 10-2021-0069180, filed in Korea on May 28, 2021, the disclosure of which is incorporated herein by reference in its entirety.

### BACKGROUND

### 1. Field

An electric range and a method for controlling an electric range are disclosed herein.

### 2. Background

Various types of cooking utensils or electric appliances are used to heat food or other items (hereinafter, collectively “food”) at home or in a restaurant. Such cooking electric appliances may include gas range using gas and electric ranges using electricity.

An electric range may be largely classified into a resistance heating type and an induction heating type. An electrical resistance type may generate heat by applying a current to a non-metallic heating element, such as a metal resistance wire and silicon carbide, and may heat an object, for example, a cooking vessel or container, such as a pot or a frying pan, by radiating or conducting the generated heat. An induction heating type may apply high-frequency power to a coil and generate a magnetic field around the coil, and may heat a heating target made of a metal material using an eddy current generated in the magnetic field.

In other words, when a current is applied to a working coil or a heating coil, a heating target may be induction-heated to generate heat and the heating object may be heated by the generated heat. A conventional induction heating type electric range having the above configuration includes a heating portion or heater on which a working coil is wound, and a cover plate disposed on an upper surface of the heater.

The cover plate may have a heating target seated thereon to be induction-heated. The heater may include a temperature sensor configured to indirectly measure a temperature of a heating target to be induction-heated, and a fuse configured to sense overheating of the heater as a safety device. The temperature sensor and the fuse may be disposed in the heater. A temperature of the cover plate is measured to indirectly estimate the temperature of the heating target and detect whether the heater is overheated.

Korean Patent Laid-Open Publication No. 10-2016-0025170 (Patented Document 1), which is hereby incorporated by reference, discloses a configuration for detecting overheat of a heater using a fuse disposed in a center of the heater. However, a fuse of the electric range disclosed in Patented Document 1 may constitute a circuit separate from the temperature sensor and may be electrically connected to a controller. As a separate sensor circuit must be provided, manufacturing costs might disadvantageously increase and a configuration of a substrate on which the controller is disposed might become complicated.

In general, a conventional fuse applied to an electric range is a non-return type fuse that cannot be restored to its original state when an internal circuit of the fuse is opened by overheating. For this reason, there might be a problem in that it is inevitably inconvenient to replace a fuse in the electric range.

### BRIEF DESCRIPTION OF THE DRAWINGS

Embodiments will be described in detail with reference to the following drawings in which like reference numerals refer to like elements, and wherein:

FIG. 1 is an exploded perspective view of an electric range according to an embodiment;

FIG. 2 is an exploded perspective view showing components of the electric range shown in FIG. 1, except a cover plate;

FIG. 3 is an exploded perspective view of a heater and an upper bracket shown in FIG. 2;

FIG. 4 is a perspective view showing an assembled state of a base bracket, a control circuit board module, and a ventilation module disposed in a case shown in FIG. 2;

FIG. 5 is a perspective view showing a coupled state of the control circuit board module and the ventilation module with respect to the base bracket shown in FIG. 4;

FIG. 6 is an exploded perspective view of an air guide removed from FIG. 4;

FIG. 7 is a top perspective view of a first heater shown in FIG. 2;

FIG. 8 is a bottom perspective view of the first heater shown in FIG. 7;

FIGS. 9 and 10 are perspective views of a first temperature sensor provided in a first heater according to an embodiment;

FIGS. 11 and 12 are schematic views of an inner connection structure of a connector shown in FIGS. 9 and 10;

FIG. 13 is a block diagram of a controller provided in an electric range according to an embodiment; and

FIG. 14 is a flow chart of a method for controlling an electric range according to an embodiment.

### DETAILED DESCRIPTION

Aspects, features, and advantages are specifically described hereinafter with reference to the accompanying drawings such that one having ordinary skill in the art to which embodiments pertain can easily implement the technical spirit. Hereinafter, descriptions of known technologies in relation to embodiments are omitted if they are deemed to make the gist unnecessarily vague. Hereinafter, embodiments are described with reference to the accompanying drawings. In the drawings, identical reference numerals can denote identical or similar components.

The terms “first” and “second”, for example, are used herein only to distinguish one component from another component. Thus, the components should not be limited by the terms. Certainly, a first component can be a second component unless stated to the contrary.

Throughout, each element may be singular or plural, unless stated to the contrary.

Hereinafter, expressions of ‘a component is provided or disposed in an upper or lower portion’ may mean that the component is provided or disposed in contact with an upper surface or a lower surface. The present disclosure is not intended to limit that other elements are provided between the components and on the component or beneath the component.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Terms such as “include” or “has” are used herein and should be understood that they are intended to indicate an existence of several components, functions or steps, disclosed in the specification, and it is also understood that greater or fewer components, functions, or steps may likewise be utilized.

Throughout, the terms “A and/or B” as used herein can denote A, B or A and B, and the terms “C to D” can denote C or greater and D or less, unless stated to the contrary.

Hereinafter, embodiments will be described, referring to the accompanying drawings showing a configuration of an electric range 1 according to an embodiment.

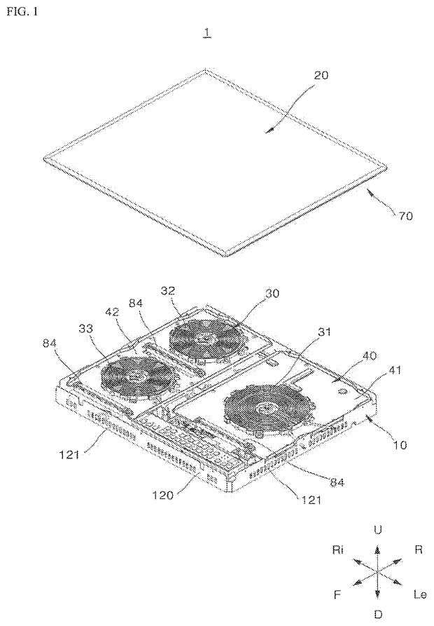

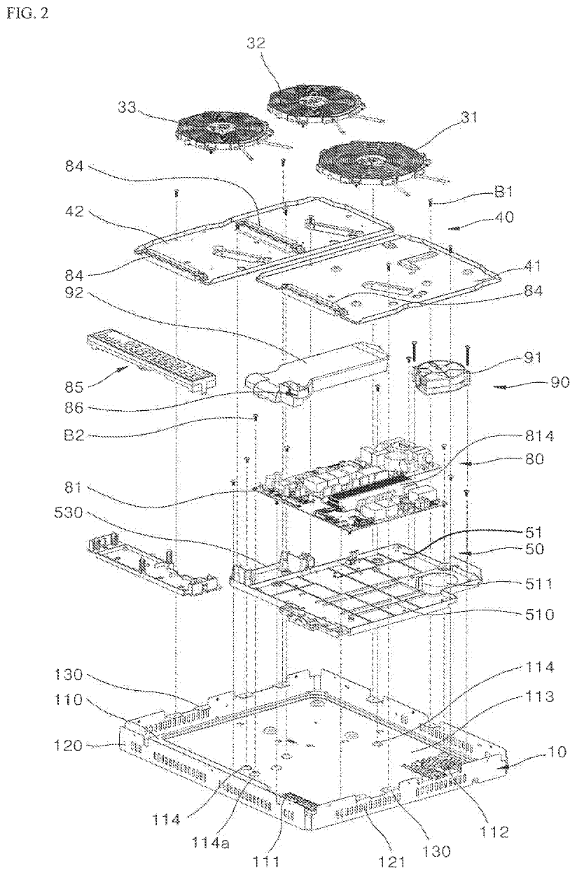

FIG. 1 is an exploded perspective view of an electric range according to an embodiment, in a state in which a cover plate is removed. FIG. 2 is an exploded perspective view showing components of the electric range shown in FIG. 1, except the cover plate. Referring to FIGS. 1 and 2, electric range 1 according to an embodiment will be described.

The electric range 1 according to this embodiment may be configured to heat a heating target based on an induction heating method. The heating target may be a tableware containing a metal material, for example, stainless steel and iron.

In the induction heating method, high-frequency power may be applied to a working coil 312, 322, and 332 to generate a magnetic field around the working coil 312, 322, and 332, and an eddy current generated by the magnetic field may be used in heating a heating target made of a metal material. More specifically, high-frequency power may be applied to a heating portion or heater 30 having a structure in which the working coil 312, 322, and 332 is disposed adjacent to a ferrite core, so that a magnetic field may be generated around the working coil 312, 322, and 332. When a heating target is placed in an area in the generated magnetic field, an eddy current may be induced in the heating object by the magnetic field and Joule's heat may be generated by the eddy current to heat the heating target. As the heating target is heated, food contained in the heating target may be heated.

The electric range may include a cover plate 20, the heater 30, an upper bracket 40, and a base bracket 50. The case 10 may be configured to define an exterior of the electric range and protect components of the electric range. For example, the case 10 may be made of a lightweight metal material, such as aluminum, for example; however, embodiments are not limited thereto.

The case 10 may be insulated to suppress heat generated by the working coil 312, 322, and 332 from being radiated to the outside. The case 10 may accommodate components of the electric range 1, such as the heater 30, the upper bracket 40, and a control circuit board module 80. A top of the case 10 may be open, and the open top may be closed by the cover plate 20.

The case 10 may be formed in a box shape by processing a plate-shaped material, for example. The case 10 may include a first casing 110, a second casing 120, and a third casing 130. The first casing 110 may define a bottom surface of the case 10. The first casing 110 may accommodate and support internal components disposed in the above-described electric range in a downward direction (D-direction).

A plurality of extending portions formed by press working may be provided as a means for facilitating the accommodation and supporting of the internal components.

A downward extending portion 113 among the plurality of extending portions may be formed by press work to protrude the first casing 110 in a downward direction (D-direction) as a whole. The first casing 110 may protrude in the downward direction so that a space in a vertical direction (U-direction) may be secured for the internal components. In addition, a rigidity of the first casing 110 may be increased.

An upward extending portion 114 may protrude upward from the downward extending portion 113 (U-direction), and may be formed as a circular bead as shown in the drawing, for example. The upward extending portion 114 may be formed at a plurality of positions, and may support a lower surface of the base bracket 50, which will be described hereinafter, to fix the base bracket 50.

A bolt hole 114a may be formed in the upward extending portion 114 to secure the base bracket 50 by using a board securing bolt, for example, so that the board securing bolt may penetrate the bolt hole 114a to extend therethrough. More specifically, the board securing bolt for securing the base bracket 50 may secure the base bracket 50 in a direction from an upper surface to a lower surface (D-direction). As the upward extending portion 114 protrudes from the downward extending portion 113, there may be a margin for preventing the board securing bolt from extending downward over the first case 110.

The first casing 110 may include an air inlet hole 112 for through which air is drawn therein, and an air outlet hole 111 through which air is discharged therefrom, to facilitate cooling of the control circuit board module 80 provided therein and circuit elements mounted on the control circuit board module 80. As shown in FIG. 2, the air outlet hole 111 and the air inlet hole 112 may be provided in the form of a grill, thereby preventing inflow of foreign substances.

The second casing 120 may be bent from the first casing 110 and configured to define a lateral surface of the case 10. The second casing 120 may be bent from an edge of the first casing 110 in a vertical direction (U-D direction) to form a side wall of the electric range 1, so that the second casing 120 may surround the base bracket 50, which will be described hereinafter.

The second casing 120 may be formed on each side of the first casing 110 formed in a substantially quadrangular shape. The second casing 120 may reinforce a rigidity of the entire case 10. More specifically, the second casing 120 bent from the first casing 110 may be configured to prevent the plate-shaped first casing 110 from bending or being damaged by a weight of the internal components or an external force.

The second casing 120 may further include a plurality of ventilation hole 121 formed in a slit shape. The plurality of ventilation holes 121 may facilitate communication between an inside and an outside of the case 10 so that air may flow through the plurality of ventilation holes 121, thereby contributing to cooling of the internal components provided in the case 10.

A supporting flange 130 may be provided in an upper end of the second casing 120. The supporting flange 130 may be bent from an upper end of the second casing 120 toward the inside of the case 10, and may serve to support the upper bracket 140, which will be described hereinafter, from a lower surface. For example, the supporting flange 130 may be formed at a plurality of positions by bending upper ends of a left or first lateral surface, a right or second lateral surface and a rear surface of the second casing 110. A securing hole 131 for bolting fastening may be provided in each of the supporting flanges 130.

A bottom surface of the upper bracket 40 may be disposed on an upper surface of the supporting flange 130. The upper bracket 40 and the supporting flange 130 may be coupled to each other by a securing means, such as a bracket securing bolt B1, for example. A left or first lateral side end and a rear end of the first upper bracket 41 and a right or second lateral side end and a rear end of the second upper bracket 42 may be supported and coupled to each other by the supporting flange 130. The right side end of the first upper bracket 41 and the left side end of the second upper bracket 42 may be supported by a supporting bracket 530, which will be described hereinafter.

The cover plate 20 may be coupled to an upper end of the case 10 and a heating target may be placed on the upper surface of the cover plate 20. The cover plate 20 may be configured to close the open top of the case 10 to protect the internal components of the case 10.

The heating target may be placed on the upper surface of the cover plate 20 and a magnetic field generated from the heater 30 may pass through the cover plate 20 to reach the heating target. For example, the cover plate 20 may be made of a material having excellent heat resistance, such as ceramic or tempered glass, for example; however, embodiments are not limited thereto.

An input interface (not shown) configured to receive an operation input from the user may be provided on the upper surface of the cover plate 20. The input interface may be disposed on a predetermined area of the upper surface of the cover plate 20 and display a specific image.

The input interface may receive a touch input from the user, and the electric range 1 may be operated based on the received touch input. For example, the input interface may be a module configured to input a desired heating intensity or heating time by a user, and may be implemented as a physical button or a touch panel.

A touch circuit board module 85 configured to receive a user's touch manipulation input may be provided under the input interface, that is, under the cover plate 20. The touch circuit board module 85 may include a plurality of key switches 851 and a touch circuit board 851 on which the plurality of key switches 851 are mounted. The user may input a command to the touch circuit board module 85 via the plurality of key switches 851 to control operation of the electric range 1.

In the electric range 1 according to an embodiment, an upper surface of the touch circuit board module 85 may be in close contact with a lower surface of the cover plate 20. The touch circuit board module 85 may be disposed at a position corresponding to the input interface.

The touch circuit board module 85 and the input interface may be connected to each other by a capacitive touch input method. Accordingly, when the user inputs a control command to the input interface, the control command may be input to the touch circuit board module 85.

In addition, a display may be provided on or at a predetermined area of the upper surface of the cover plate 20 and configured to display an operation state of the electric range 1. A light display region may be formed on the upper surface of the cover plate 20. A light emitting diode (LED) substrate module 84 may be disposed under the cover plate 20, corresponding to the light display region. The light irradiated from the LED substrate module 84 may be transmitted to the user via the light display region. For example, the LED substrate module 84 may be fixedly disposed on the upper bracket 40, which will be described hereinafter. The upper bracket 40 may include a plurality of substrate supporting portions or supports 417 and 427 to support the LED substrate module 84.

The light display region and the LED substrate module 85 may be disposed in or at positions corresponding to each other. When a plurality of LED substrate modules 84 is provided, a same number of light display regions may be disposed on the upper surface of the cover plate 20.

The electric range 1 according to one embodiment may further include a cover bracket 70 configured to support the cover plate 20 and connect the cover plate 20 to the case 10. As shown in FIG. 1, the cover bracket 70 may be disposed on or at an outside of the upper bracket 40 and the case 10, and may be coupled to the case 10, to support the cover plate 20. For example, the cover bracket 70 may be coupled to the case 10 by a securing means, such as a case securing bolt (not shown), for example.

A plurality of the cover bracket 70 may be provided, and each of the plurality of cover brackets 70 may be disposed on or at a position corresponding to each side of the cover plate 20 formed in a quadrangle. For example, a total of fourth cover brackets 70 may be disposed on respective sides of the rectangular cover plate 20.

A plurality of the heaters 30 may be provided disposed under the cover plate 20, to heat a heating target. A total of three heaters 30 are shown in the accompanying drawings.

The plurality of heaters 30 may all employ the induction heating method, or some of the heaters 30 may employ the induction heating method and the others may be a highlight heating device using an electric resistance heating method, so that the electric range 1 may be configured as a so-called “hybrid range”.

Hereinafter, the electric range 1 including a plurality of heaters 30 all employing the induction heating method will be described.

The plurality of heaters 30 may be configured to have a same heating capacity or different heating capacities from each other. The accompanying drawings show an example of the plurality of heaters including first heater 31, second heater 32, and third heater 33; however, embodiments are not be limited thereto. An example of the first heater 31, the second heater 32, and the third heater 33 having different heating generation capacities will be described as a standard.

The first heater 31 may be secured to the first upper bracket 41. The second heater 32 and the third heater 33 may be secured to the second upper bracket 42.

The heaters 31, 32, and 33 may include core frames 311, 322, and 332, respectively. The working coils 312, 322, and 332 may be spirally wound around upper surfaces of the core frames 311, 321, and 331, respectively, and ferrite cores 313, 323, and 333 may be mounted on lower surfaces of the core frames 311, 321, and 331, respectively. Accordingly, when high-frequency power is applied to the working coils 312, 322, and 332, a magnetic field may be formed around the ferrite core 313, 323, and 333, and an eddy current may be formed in a heating target by the formed magnetic field.

Each of the working coils 312, 322, and 332 may include a pair of outgoing wires 312a, 322a, and 332a. An outgoing tip terminal may be provided at ends of each lead wire 312a, 322a, and 332a.

A temperature sensing portion or sensor 60 may be provided in a center of each heater 31, 32, and 33. More specifically, a first temperature sensing portion or sensor 61 may be provided in the first heater 31, and a second temperature sensing portion or sensor 62 may be provided in the second heater 32. A third temperature sensing portion or sensor 63 may be provided in the third heater 33.

The first temperature sensor 61 may include a first plate temperature sensor 611 configured to sense a temperature of the cover plate 20 directly above the first heater 31, a first thermal fuse 613 configured to detect whether the temperature of the cover plate 20 increases above a preset or predetermined threshold temperature, a first coil temperature sensor 612 configured to sense a temperature of the first working coil 312, and a first sensor holder 614 in which the first plate temperature sensor 611 and the third thermal fuse 613 are mounted. Similarly, the second temperature sensor 62 and the third temperature sensor 63 may have substantially a same configuration as the first temperature sensor 61, respectively. The second temperature sensor 62 may include a second plate temperature sensor 621, a second coil temperature sensor 622, a second thermal fuse 623, and a second sensor holder 624. The third temperature sensor 63 may include a third plate temperature sensor 631, a third coil temperature sensor 632, a third thermal fuse 633, and a third sensor holder 634.

The first to third plate sensors 611, 621, and 631 may directly contact a lower surface of the cover plate 20 so as to measure the temperature of the cover plate 20. Sensing surfaces may be disposed to maintain a contact state with the lower surface of the cover plate 20 at all times.

The first to third coil temperature sensors 612, 622, and 632 may be disposed on lower surfaces of the working coils 312, 322 and 332, and may directly contact the working coils 312, 322 and 332 so as to measure the temperature of the working coils 312, 322 and 332. Sensing surfaces may be disposed to maintain a contact state with the working coils 312, 322 and 332 at all times.

The first to third fuses 613, 623, and 633 may serve as a kind of a thermostat configured to disconnect an internal circuit when the temperature of the cover plate 20 increases above a preset or predetermined threshold temperature. When internal circuits of the first to third thermal fuses 613, 623, and 633 are cut off, the power supplied to the working coils 312, 322 and 332 may be immediately cut off to discontinue operation of the heaters 31, 32 and 33 in which overheating occurs.

The heaters 31, 32 and 33 may be disposed on and supported by the upper bracket 40. As in the example shown in the drawing, a plurality of the upper bracket 40 may be provided. The upper bracket 50 may include first upper bracket 41 that supports the first heater 31, and second upper bracket 42 that supports the second heater 32 and the third heater 33.

The upper bracket 40 may be made of a lightweight metal material, for example, aluminum; however, embodiments are not be limited thereto. The first upper bracket 41 may include a first upper plate 411 and a second upper plate 412. The first upper plate 411 may define a bottom surface of the first upper bracket 41 and the first heater 31 may be mounted on the first upper plate 411. The second upper bracket 42 may include a first upper plate 421 and a second upper plate 422. The first upper plate 421 may define a bottom surface of the second upper bracket 42, and the second heater 32 and the third heater 33 may be mounted on the first upper plate 421.

The first upper plate 411 of the first upper bracket 41 and the first upper plate 421 of the second upper bracket 42 may completely cover a main circuit board module 81 and a power circuit board module 83 provided under the first upper plates 411, 421 in the vertical direction (U-D direction). Due to this structure, the first upper plate 411 of the first upper bracket 411 and the first upper plate 421 of the second upper bracket 42 may serve to shield the electromagnetic field and electromagnetic waves generated from the heater 30 from reaching elements mounted on the main circuit board module 81 and the power circuit board module 83. More specifically, the first upper bracket 41 and the second upper bracket 42 may be configured to improve electromagnetic compatibility (EMC) and electromagnetic interference (EMI) performance of the circuit boards.

The second upper plate 412 of the first upper bracket 41 and the second upper plate 422 of the second upper bracket 422 may be bent from respective first upper plates 411 and 421 in the vertical direction (U-D direction) of the electric range 1. As shown in the drawing, the second upper plates 412 and 422 may be formed at sides of the first upper plates 411 and 421 formed in a substantially quadrangular shape.

A rigidity of the first upper bracket 41 and the second upper bracket 42 may be reinforced as a whole by the second upper plates 412 and 422. That is, the second upper plates 412 and 422 may prevent the plate-shaped first upper plates 411 and 421 from being bent or damaged by the weight of the internal components including the heater 30 or an external force.

Each of the first upper plates 411 and 421 may include the pair of outgoing wires 312a, 322a and 332a discussed above, and a plurality of insertion holes penetrated by lead wires (not shown) of the temperature sensor 60. For example, the plurality of insertion holes may include a first insertion hole 414 and 424 through which one of the pair of the outgoing wires 312a, 322a, and 332a passes, and a second insertion hole 415 and 425 through which the other one of the outgoing wires passes, and a third insertion hole 416 and 426 through which a lead wire of the temperature sensor 60 passes. The pair of lead wires 312a, 322a, and 332a and the lead wire of the temperature sensor 60 may pass through the insertion holes and extend in the downward direction (D-direction), thereby being electrically connected to the control circuit board module 80.

In addition, the first upper plate 411 and 421 may include a plurality of extending portions that protrudes in the upward direction (U-direction) or the downward direction (D-direction). The plurality of extending portions that protrudes in the downward direction (D-direction) may be referred to as an anti-pressing portions 411a, 421a. The anti-pressing portions 411a, 421a may serve to prevent the lead wires 312a, 322a that extend outward in a radial direction (r-direction_from a center of each heaters 31, 32, and 33 among the pair of lead wires 312a, 322a, and 332a from being pressed in a mounting process of the heaters 31, 32, and 33. More specifically, the anti-pressing portions 411a, 421a may serve as passages for the outgoing wire 312a, 322a, and 332a that extend outward from the center of the heaters 31, 32, and 33.

The extending portion that protrudes in the upward direction (U-direction) may be referred to as a securing portion 413. The securing portion 413 may support the heaters 31, 32, and 33, and may prevent the securing means, such as bolts, from extending in the downward direction (D-direction) after passing through the first upper plate 411 and 421. In other words, the securing portion 413 may provide a margin for preventing the securing means, for example, bolts, from interfering with the control board circuit module 80 disposed in the downward direction (D-direction).

The LED substrate module 84 may be disposed on each of the first upper bracket 41 and the second upper bracket 42. Substrate support portions 417 and 427 that support the LED substrate module 84 may be formed in the first upper plate 411 of the first upper bracket 41 and the first upper plate 421 of the second upper bracket 421, respectively. The substrate supporting portions 417 and 427 may be formed by partially cutting-away the first upper plate 411 of the first upper bracket 41 and the first upper plate 421 of the second upper bracket 42.

In the example shown in the drawing, one substrate supporting portion 417 may be provided in the first upper bracket 41 on which the first heater 31 is disposed. Two substrate supporting portions 427 may be formed in the first upper bracket 41 on which the second heater 32 and the third heater 33 are disposed.

A plurality of LEDs may be aligned on the LED substrate module 84. The plurality of LEDs may be luminescent when the heater 30 is turned on so that the user may be visually informed of whether the heater 30 is in operation or an operation state. The LED substrate module 84 may change a luminescent shape, and/or color, for example, of the plurality of LEDs to inform the user whether or not the electric range 1 is operating and the operation state.

The base bracket 50 may be disposed under the first upper bracket 41. The main circuit board module 81, and the power circuit board module 83 of the control circuit board module 80 may be mounted on the base bracket 50. The base bracket 50 may support the main circuit board module 81, the power circuit board module 83, and a ventilation module 90. The upward extending portions 114 formed in the first casing 110 may support a lower surface of the base bracket 50 at a plurality of positions.

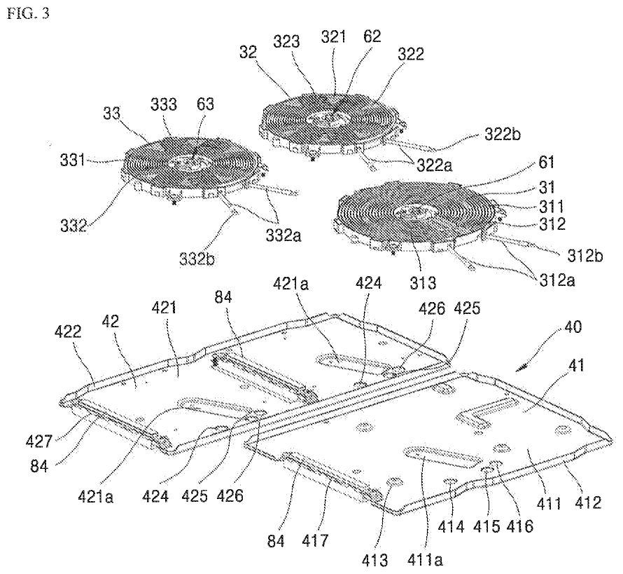

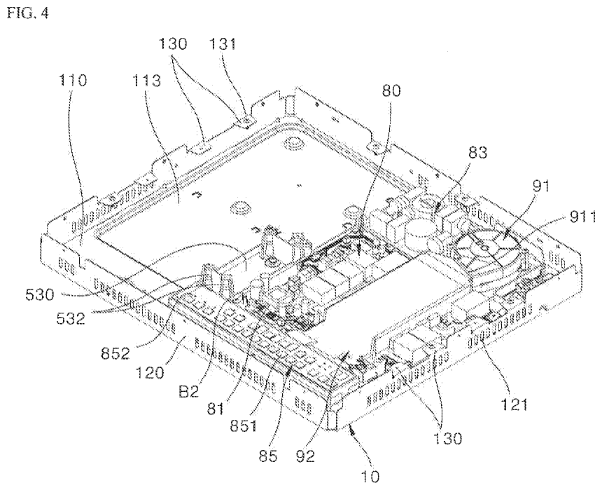

As shown in FIGS. 3 and 4, the base bracket 50 may include a substrate bracket 51 including a bottom plate 510 and a lateral plate 520. The bottom plate 510 may define a bottom surface of the base bracket 50. The main circuit board module 81, the power circuit board module 83, and the ventilation module 90 may be mounted on an upper surface of the bottom plate 510.

Substrates 811 and 831 provided in the main circuit board module 81 and the power circuit board module 83 may be secured to the bottom plate 510 via a plurality of substrate securing bolts B2. Each substrate securing bolt B2 may extend to the upward extending portion 114 of the first casing 110 to be screw-fastened. The substrates 811 and 831 of the main substrate module 81 and the power circuit module 83 and the bottom plate 510 may be secured at the same time to the upward extending portion 114 of the first casing 110 using the substrate securing bolt B2.

Further, any one of the substrate securing bolts B2 may be configured to act as

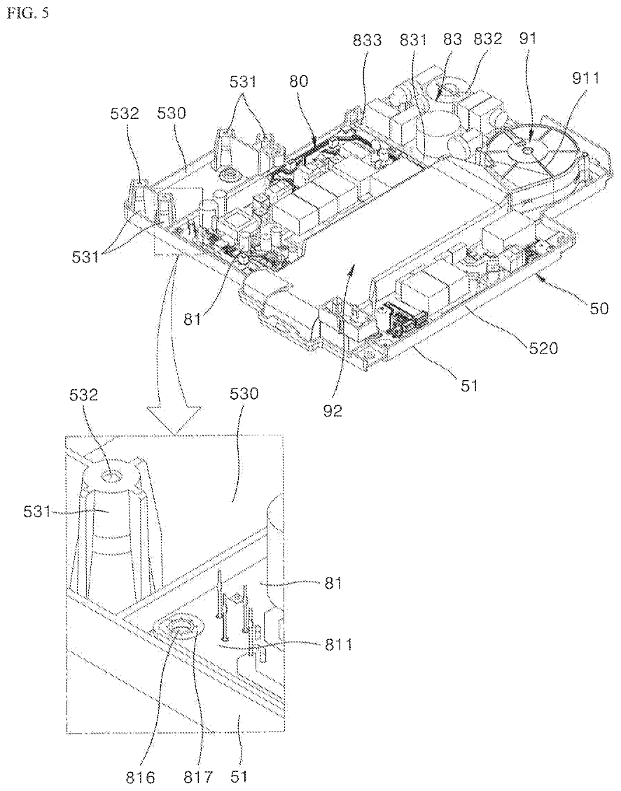

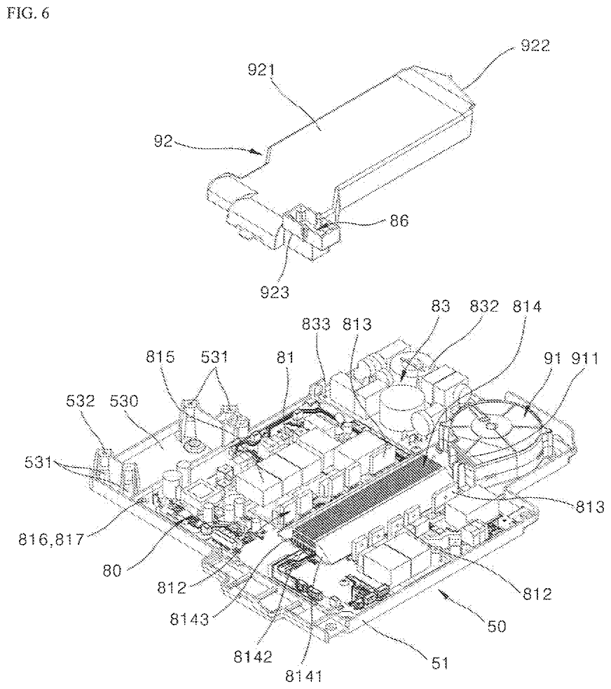

a grounding means for grounding the main circuit board module 81 and the power circuit board module 83. For example, as shown in FIG. 5, a copper-foil-shaped ground terminal 817 may be formed around a bolt hole 816 of the main circuit board module 81 through which the substrate securing bolt B2 extends, and a head of the substrate securing bolt B2 may be electrically connected to the ground terminal 817. A stem of the substrate securing bolt B2 may be physically and electrically connected to the upward extending portion 114 of the first casing 110. Through such a simple configuration, the main circuit board module 81 may be effectively grounded to the first casing 110 by the substrate securing bolt B2. Although not shown, a same type of a ground terminal (not shown) may be provided in any one of the plurality of bolt holes 833 formed in the substrate 831.

The lateral plate 520 may extend in the upward direction (U-direction) of the electric range 1 from a lateral surface edge of the bottom plate 510. The lateral plate 520 may serve to reinforce the rigidity of the entire base bracket 50. That is, the lateral plate 520 may prevent the plate-shaped bottom plate 510 from being bent or damaged by the weight of the internal components, for example, the circuit board, or an external force. Further, the lateral plate 520 may also serve to protect the main circuit board module 81, the power circuit board module 83, and the ventilation module 90 from the external force applied to the bottom plate 510 in a lateral direction or frontward-rearward direction (F-R direction). For that, the lateral plate 520 may protrude to a position higher than a position in the vertical direction (U-D direction) of at least the main circuit board 811 and the power circuit board 831.

A supporting bracket 530 configured to support the first upper bracket 41 and the second upper bracket described above may be provided in or at a position corresponding to a center of the electric range 1. The supporting bracket 530 may extend parallel to a lateral surface of the substrate bracket 51 and a right surface with respect to the drawing. The supporting bracket 530 may be integrally formed with the substrate bracket 51. At this time, the supporting bracket 530 may be integrally formed with the substrate bracket 51, but may be configured to be easily decoupled from each other by an external force. For example, a connection portion between the supporting bracket 530 and the substrate bracket 51 may have a relatively weak strength.

The supporting bracket 531 may include a plurality of supporting bosses 531 that extends in the upward direction (U-D direction) from a bottom surface a first upper bracket toward the first upper bracket 41 and the second upper bracket 42 described above.

As mentioned above, left and rear ends of the first upper bracket 41 and right and rear ends of the second upper bracket 42 may be supported by and coupled to the supporting flanges 130. The right end of the first upper bracket 41 and the left end of the second upper bracket 42 may be supported and secured by the supporting bosses 531 of the supporting bracket 530. To couple the right end of the first upper bracket 41 and the left end of the second upper bracket 42 to each other, a coupling hole 532 may be formed in an upper end of each supporting boss 531.

In the example shown in the drawing, a total of five supporting bosses 531 may be provided in the supporting bracket 530. Not all of the five supporting bosses 531 may be used in coupling the right end of the first upper bracket 41 and the left end of the second upper bracket 42. For example, only three supporting bosses 531 out of the five supporting bosses 531 may be used in the coupling between the first upper bracket 41 and the second upper bracket 42.

The other supporting bosses 531 not used in the coupling according to the illustrated example may be used when the supporting bracket 530 supports the first upper bracket 41 and the second upper bracket 42 at a different position in another example. More specifically, when applied to another example of an electric range having a larger size than the electric range described above, the supporting bracket 530 may be decoupled from the substrate bracket 51 and moved to another position. When the supporting bracket 530 is applied to the larger-sized electric range, the other supporting bosses 531 not used in the coupling in this example may be used. The supporting bracket 530 is configured to be applicable to other examples, thereby facilitating component sharing and reducing manufacturing costs.

As described above, the main circuit board module 81 and the power circuit board module 83 of the control circuit board module 80 may be mounted on the base bracket 50. Although not limited thereto, the control circuit board module 80 may be understood as a higher concept including the above-noted LED substrate module 84, the touch circuit board module 85, and wireless communication substrate module 86 rather than the main circuit board module 81 and the power circuit board module 83.

As shown in FIGS. 3 and 4, the main circuit board module 81 may include a controller configured to control overall operation of the electric range 1, and may be electrically connected to the touch circuit board module 85 and the LED substrate module 84 described above. Accordingly, the main circuit board module 81 may receive a user's manipulation through the touch circuit board module 85 or a user's manipulation through the wireless communication board module 86 wirelessly or wiredly. The main circuit board module 81 may transmit operational information and status information to the LED substrate module 84 and a user's mobile terminal (not shown).

In addition, on or at a center of the main circuit board 811 may be mounted a CPU provided as a controller, that is, a microcontroller, a microcomputer or a microprocessor, a plurality of switching elements or switches 812 configured to convert power received from the power circuit board module 83 into high-frequency power and supply the converted power to the working coils 312, 322, and 332, and a bridge circuit element 813. The plurality of switching elements 812 may serve as a power converting module.

A plurality of insulated gate bipolar transistors (IGBT) may be applied as the plurality of switching elements. However, a IGBT type switching element is a very heat-generating component. If such generated heat is not maintained at an appropriate level, a life span of the switch element will be shortened or a malfunction of the switch element is highly likely to occur.

As a means for cooling the plurality of switching elements 812, a heat sink 814 configured to absorb heat generated in the plurality of switching elements 812 and the bridge circuit element 813 may be mounted on the main circuit board 811. As shown in FIG. 5, the heat sink 814 may include a hexahedral main body 8141 that extends along the frontward-rearward direction (F-R direction) of the electric range 1, and a plurality of heat dissipation fins 8143 that extends toward the main circuit board 811 from a lower surface of the body 8141.

An upper surface of the main body 8141 may be formed in a plane parallel to the main circuit board 811. Both lateral surfaces of the main body 8141 may be formed as inclined surfaces having a downward inclination.

The plurality of switching elements 812 and the bridge circuit element 813 may be attached to the lateral surfaces having the downward inclination. Accordingly, heat generated by the plurality of switching element 812 and the bridge circuit element 813 may be conducted through the lateral surfaces of the main body 8141.

A flow channel 8142 may be provided in the main body 8141, and extend in a straight line through front and rear surfaces of the main body 8141. Air may flow along the airflow channel 8142 to a ventilation fan-motor assembly 91 which will be described hereinafter. Heat from the plurality of switching elements 812 and the bridge circuit element 813 may be partially absorbed by the air flow inside of the airflow channel 8142.

Concavities and convexities (or unevennesses) may be formed on an inner surface of the airflow channel 8142 and an upper surface of the main body 8141 to expand a contact area for the air flow. The unevenness may extend in a straight line along an air flow direction, that is, in the frontward-rearward (F-R direction) to minimize flow resistance.

The plurality of heat dissipation fins 8143 may protrude from a lower surface of the main body 8141 and extend in the straight line, spaced a constant distance apart from each other. Accordingly, an air passage may be formed between each two neighboring heat dissipation fins adjacent to each other.

Some of the heat dissipation fins, in particular, the ones disposed adjacent to both lateral sides of a lower surface of the main circuit board 811 may directly contact the main circuit board 811. These heat dissipation fins may serve to support the heat sink 814 as a whole.

In a state in which the plurality of switching elements 812 and the bridge circuit element 813 are attached to the heat sink 814, the heat sink 814 may be covered by an air guide 92, which will be described hereinafter. The heat sink 814 may be spatially separated from other circuit elements outside of the air guide 92 by the air guide 92 of the ventilation module 90, and a cooling passage only for the heat sink may be formed by the air guide 92.

As shown in the drawing, a plurality of filter elements 815 may be disposed at a periphery of the air guide 92 to remove noise included in power output from the power circuit board module 83, which will be described hereinafter. The power circuit board module 83 may be disposed behind the main circuit board module 81. In general, the power circuit board module 83 may be modularized by mounting a high voltage device known as a switching mode power supply (SMPS) on the power circuit board 831. The power circuit board module 83 may convert external power into a stable-stated power before it is supplied to the switching elements 812.

The ventilation fan-motor assembly 91 of the ventilation module 90 may be disposed behind the main circuit board module 81, for example, on the base bracket 50 disposed behind the heat sink 814. The ventilation fan-motor assembly 91 may absorb external air drawn via the air inlet hole 112 of the first casing 110 and the through-hole 511 of the base bracket 50, and blow the air into the air guide 92.

As shown in the drawings, a ventilation fan applied to the ventilation fan-motor assembly 91 may not be limited; however, a sirocco fan may be used in consideration of location and spatial restrictions in which the ventilation fan is mounted. When the sirocco fan is applied, external air may be absorbed in from a bottom of the sirocco fan in a direction parallel to a rotational shaft, and the air may be accelerated and discharged radially outward.

To improve air ventilation efficiency, an outlet end 911 of the ventilation fan may be directly connected to an inlet of the air guide 92. External air forcedly blown by the ventilation fan may be drawn into the air guide 92 as a whole.

The air guide 92 may include a guide body 921 having a U-shaped cross-section and formed in a box shape, in a lower surface of which is open. The heat sink 814 may be mounted in an internal U-shaped space and the cooling passage dedicated to the heat sink 814 may direct the external air blown by the above-mentioned ventilation fan.

The guide body 921 may correspond in shape to the heat sink 814. When the guide body 921 extends along the frontward-rearward direction (F-R direction) of the electric range 1, as shown in FIG. 5, the heat sink 815 may be correspondingly arranged in a shape that extends along the frontward-rearward direction (F-R direction) of the electric range.

A rear surface of the guide body 921 may be partially open. The open rear surface may serve as an air introduction hole 922 through which the external air blown by the ventilation fan is introduced. Unlike the rear surface, a front surface and a lateral surface of the guide body 921 may be completely closed, and may perform a function of a partition wall configured to prevent the introduced external air from leaking to the outside.

The external air introduced into the cooling passage formed in the guide body 921 may flow forward while performing heat-exchange with the heat sink 814, The flow direction of the external air may be guided by the guide body 921 to finally flow in the downward direction (D-direction), thereby being discharged to the outside through the air outlet hole 111 of the first casing 110.

A substrate mounting portion or mount 923 may be integrally formed with a front surface of the guide body 921, for example, a front left or first lateral area of the front surface. The substrate mounting portion 923 may protrude from the front left area in the upward direction.

The substrate mounting portion 923 may accommodate the above-mentioned wireless communication substrate module 86. A position of the substrate mounting portion 923 may be determined as a position which may minimize the influence of high-frequency noise generated by the heater 30 and the plurality of switching elements 812. A position which is most distant from the heater 30 and the plurality of switching elements 812 may be selected.

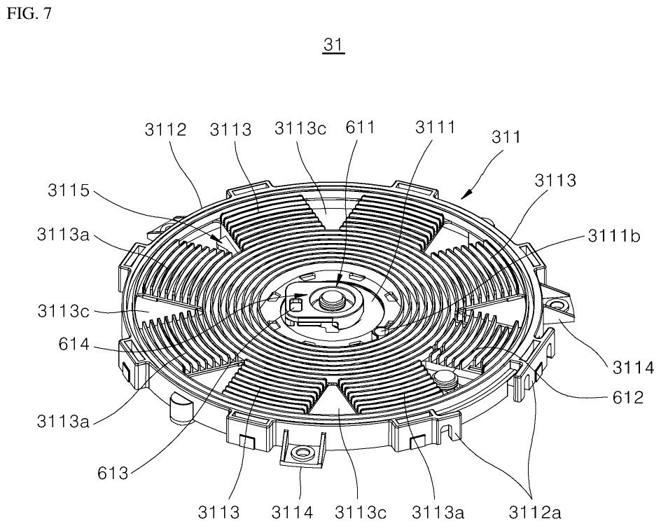

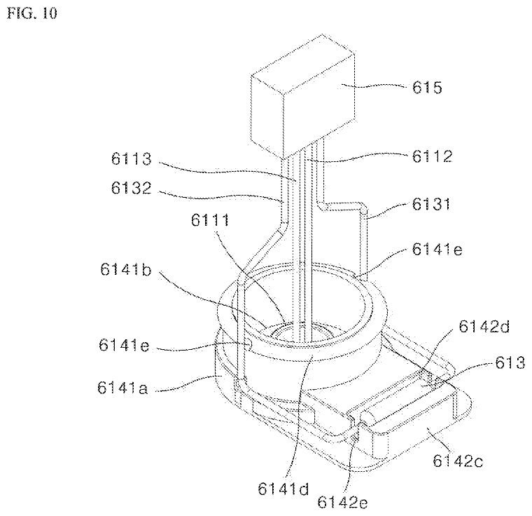

Referring to FIG. 7, of the heater 30 provided in the electric range 1 according to an embodiment will be described hereinafter. Referring to FIGS. 7-13, the first heater 31 will be described among the first to third heaters 31, 32, and 33 of the heater 30 as an example. Unless otherwise described hereinafter, the configuration of the first heater 31 may be almost identically applicable to the second heater 32 and the third heater 33, and repetitive description has been omitted.

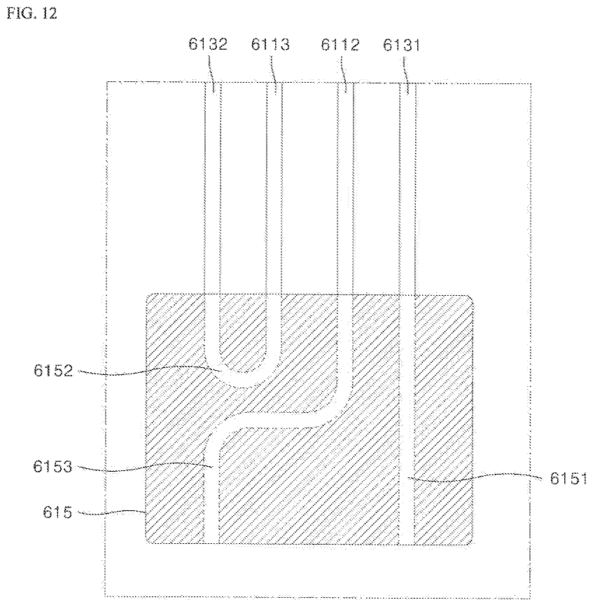

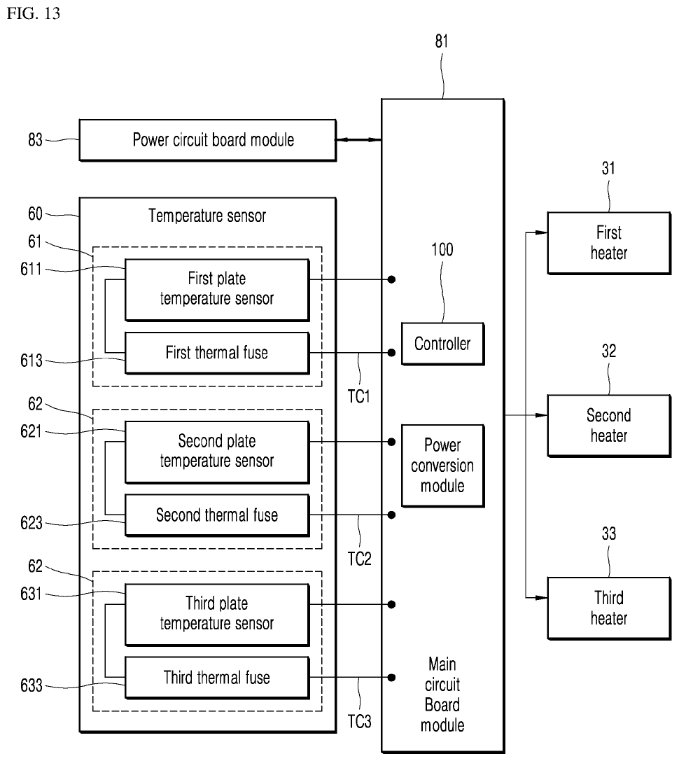

Referring to FIGS. 7 to 9, the first heater 31 may include working coil 312, core frame 311, and ferrite core 313. In FIGS. 7 to 9, the working coil 312 is omitted to describe the structure of the first heater 31 more clearly. However, as the first heater 31 on which the working coil 312 is wound is shown in other drawings, for example, FIGS. 12 and 13, there will be no difficulty in understanding the embodiments.

As shown in the drawings, the core frame 311 may be formed in a hollow cylindrical shape with an empty interior as a hole, and a lower surface thereof may be entirely open. The working coil 312 may be spirally wound on an upper surface of a disk portion or disk 3111 corresponding to an upper surface of the core frame 311. To facilitate the spiral winding of the working coil 312, a guide rail 3113 may be provided on an upper surface of the disk portion 3111 and the guide rail 3113 may extend in a spiral shape while extending in the radial direction outside of the disk portion 3111 toward the radial direction inside thereof.

The guide rail 3113 may have a predetermined height in the upward direction (U-direction) from an upper surface of the disk portion 3111. A radial track 3113a may be provided between neighboring guide rails 3113 and the working coil 312 may be accommodated in the radial track 3113a.

A height of a protruding area of the guide rail 3113 may be greater than a diameter of the working coil 312 so as not to expose the working coil 312 in the upward direction (U-direction). In addition, when the working coil 312 is wound several times in multiple layers, the height of the guide rail 3113 may correspond to the number of layers of the working coil 312.

An upper end of the guide rail 3113 may be in directly contact with the lower surface of the cover plate 20 described above, and may be configured to support a load of a heating target which will be placed on the upper surface of the cover plate 20.

The core frame 311 of the disk portion 3111 may include a through hole 3113c formed in the vertical direction (U-D direction). The through hole 3113c may penetrate up to the guide rail 3113. That is, the through hole 3113c may facilitate communication between an inside and an outside of the core frame 311.

The through hole 3113c may be formed between core accommodating portions, which will be described hereinafter. More specifically, the disk portion 3111 and the guide rail 3113 provided between neighboring core accommodating portions 3113b may be partially open in the vertical direction (U-D direction) by the through hole 3113c.

As shown in FIGS. 7 to 9, a total of eight core accommodating portions 3113b may be provided as one example, and a total of eight through-holes 3113c may be formed correspondingly. The number of the core accommodating portions 3113b and the number of the through holes 3113c may be applied differently based on a size and heat generation load capacity of the first heater 31. However, embodiments are not limited thereto, but will be described based on an exemplary embodiment in which a total of eight through holes 3113c is provided.

As shown in the drawings, each through hole 3113c may be provided in a polygonal shape that gradually increases in width while extending outward in the radial direction (r-direction), and may be provided in a fan shape, for example. Such a shape of the through hole 3113c may be selected from any one that avoids the shape of the core accommodating portion 3113b and the shape of the ferrite core 313.

The inside and the outside of the through hole 3113c may be in communication with each other. Accordingly, the through hole 3113c may function as a passage through which heat transferred from the cover plate 20 and heat generated from the working coil 312 may escape to the outside without being trapped inside the core frame 311.

A cable guide wall 3116 may be provided under the disk portion 3111, and the cable guide wall 3116 may protrude in the downward direction (D-direction) along a circumference of the through hole 3113c. The cable guide wall 3116 may partition off the lead wire of the first thermal fuse and the outgoing wire (322a, see FIG. 3) of the working coil 322 from each other and guide them, thereby forming an extension passage thereof. The extension passage of the lead wires and the outgoing wires may be formed together by the cable guide wall 3116 and an accommodation wall of the core accommodating portion 3113b.

As shown in the drawings, the sensor bracket 3115 may be formed in the through hole 3113c and the first coil temperature sensor 612 may be disposed in the through hole 3113c. The sensor bracket 3115 may be formed in a flat plate shape that extends from an inner circumferential surface of the through hole 3113c to an inside of the through hole 3113c.

The working coil 312 wound around the guide rail 3113 in the radial direction and generating a magnetic field using the received high-frequency power may be made of Ritz wire having excellent durability, for example; however, embodiments are not limited thereto.

A circular area may be formed in the center of the disk portion 3111 of the core frame 311 in which the guide rail 3113 is not formed, in other words, a circular area in which the working coil is not wound. A coupling hole 3111a may be formed in the center of the circular area. The coupling hole 3111a may penetrate the disk portion 3111 in the vertical direction (U-D direction).

The first sensor holder 614 may be disposed in the coupling hole 3111a. The first plate temperature sensor 611 and the first thermal fuse 613 of the first temperature sensor 61 may be held in the first sensor holder 614.

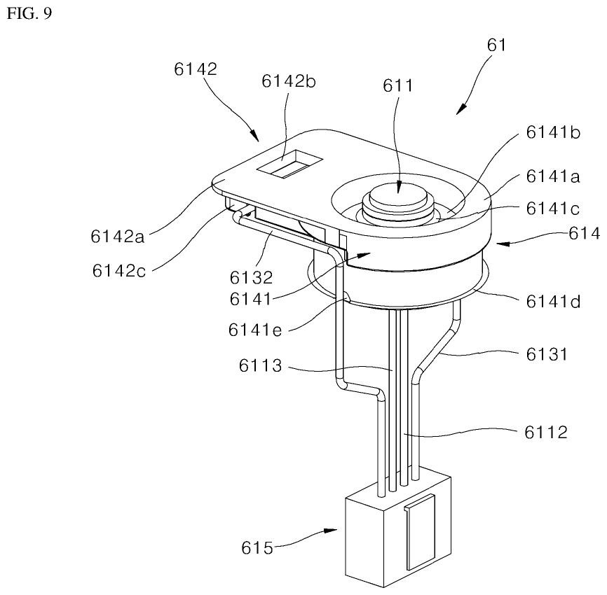

As shown in FIG. 9, the first sensor holder 614 may include a first holder 6141 that holds the first plate temperature sensor 611 and a second holder 6142 that holds the first thermal fuse 613. The first holder 6141 may be formed in a hollow cylindrical shape and the second holder 6142 may be formed in a box shape coupled to a lateral surface thereof. The first holder 6141 and the second holder 6142 may be integrally formed, and may be made of a material having a predetermined elasticity to elastically support the first plate temperature sensor 611 and the first thermal fuse 613 and having heat resistance suitable for a high temperature environment.

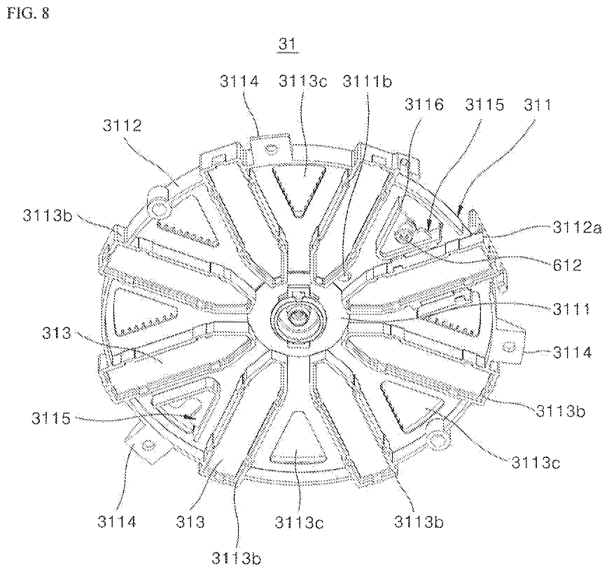

As shown in FIG. 8, a lower end of the second holder 6141 may partially pass through the coupling hole 3111a to be exposed to or at a lower surface of the disk portion 3111. Detailed configuration of the first temperature sensor 61 will be described hereinafter, referring to FIG. 9.

A coil hole 3111b may be formed at an inner end of the guide rail 3113 to guide one end of the working coil 312 or the outgoing wire (322a, see FIG. 3) of the working coil 312 in the downward direction (D-direction). The inner end of the guide rail may be a point at which the guide rail 3113 ends at an inside.

As shown in FIG. 8, a lower end of the first holder 6141 may partially pass through the coupling hole 3111a to be exposed to or at the lower surface of the disk portion 3111. The first plate temperature sensor 611 mounted to an inner central surface of the first holder 6141 may be configured to sense the temperature of the lower surface of the cover plate 20, and may detect the temperature of the cover plate 20 by direct contact with the lower surface of the cover plate 20. That is, a sensing surface formed in the upper end of the first plate temperature sensor 611 may protrude in the upward direction (U-direction) to directly contact the lower surface of the cover plate 20.

A lead wire of the first plate temperature sensor 611 may have one or a first end connected to the lower end of the first plate temperature sensor 611 and the other or a second end electrically connected to the control circuit board module 80 after passing through a cable holder 3112a formed in an edge wall portion 3112 of the core frame 311.

The first thermal fuse 613 provided in the second holder 6142 may correspond to a safety device configured to open a circuit in case of overheating occurring when the temperature of the cover plate 20 exceeds a predetermined threshold temperature. The first thermal fuse 613 may be classified into a recovery type that automatically returns to an original state when the temperature falls below a predetermined value after the circuit is open due to occurrence of overheating occurs, and a non-recovery type that does not return to the original state. The first thermal fuse 613 applied to this embodiment may be the recovery type.

Similar to the first plate temperature sensor 611, the pair of lead wires (not shown) provided in the first thermal fuse 613 may be electrically connected to the control circuit board module 80 after penetrating the cable holder 3112a formed in the edge wall 3112 of the core frame 311. At the inner end of the guide rail 3113, which is a point at which the guide rail ends at an inside, may be formed a coil hole 3111b to guide the one end of the working coil 312 or the outgoing wire (322a, see FIG. 3) of the working coil 312 in the downward direction (D-direction).

As shown in FIG. 8, the plurality of ferrite cores 313 may be disposed on a lower surface of the disk portion 3111 provided in the core frame 311. The core accommodating portions 3113b may be radially disposed on the lower surface of the core frame 311.

As shown in the drawings, the core accommodating portion 3113b may have a polygonal box shape with an entirely open lower surface, for example. Each of the core accommodating portions 3113b may be defined by an accommodating wall that protrudes in the downward direction (D-direction) from the lower surface of the disk portion 3111 of the core frame 311.

The ferrite core 313 having a same shape as an inner shape of the core accommodating portion 3113b may be accommodated in each core accommodating portion 3113b. Accordingly, the number of core accommodating portions 3113b may be the same as the number of ferrite cores 313.

The core accommodating portion 3113b may be formed so that the plurality of ferrite cores 313 disposed radially may be spaced a predetermined distance apart from each other in a circumferential direction of the core frame 311. An inner end of each core accommodating portion 3113b and an inner end of each ferrite core 313 may gradually decrease in width while extending in an inward direction to secure such a distance.

A D-direction end of the core accommodating portion 3113b may directly contact the first upper plate 411 of the first upper bracket 41 described above. A load of a heating target transmitted to the disk portion 3111 may be transmitted to the core accommodating portion 3113b along the guide rail 3113, thereby being finally transmitted to the first upper plate 411 of the first upper bracket 41. In other words, the core accommodating portion 3113b may have a dual function of accommodating the ferrite core 313 and supporting an external load inside of the core frame 311.

A cylindrical edge wall 3112 may be integrally formed with a radial-direction (r-direction) outer end of the disk portion 3111 of the core frame 311, and may extend in the downward direction (D-direction). The cylindrical-shaped edge wall 3112 may be configured to define the inner space of the core frame 311, and may be integrally formed with the disk portion 3111. A height of the edge wall 3112 may be set based on a size of the ferrite core provided in the internal space of the core frame 311.

A plurality of coupling tabs 3114 configured to couple the core frame 311 to the above-described first upper bracket 41 may be provided on an outer surface of the edge wall 3112. A coupling hole may be formed in each of the coupling tabs 3114 so that a securing means, such as a bolt, for example, may extend through the coupling hole.

A cable holder 3112a may be provided in an outer surface of the edge wall 3112 and configured to guide the lead wire of the first plate temperature sensor 611, the lead wire of the first thermal fuse 613, and the outgoing wire (322a, see FIG. 3) of the working coil 312 extend outside of the core frame 311.

Hereinafter, referring to FIG. 9, a configuration of the first temperature sensor 61 provided in the electric range 1 according to an embodiment will be described.

Referring to FIG. 9, the first temperature sensor 61 of the first heater 31 will be described among the first to third heaters 31, 32 and 33 of the heater 30. Unless otherwise described below, the configuration of the first temperature sensor 61 may be almost identically applicable to the second temperature sensor 62 and the third temperature sensor 63, and repetitive description has been omitted.

As described above, the first temperature sensor 61 may include the first plate temperature sensor 611 configured to sense the temperature of the cover plate 20 directly above the first heater 31, a first coil temperature sensor 612 configured to sense the temperature of the first working coil 312, a first thermal fuse 613 configured to sense whether the temperature of the cover plate 20 increases to a preset or predetermined threshold temperature or more, and a first sensor holder 61 configured to hold the first plate temperature sensor 611 and the first thermal fuse 613 therein. The first plate temperature sensor 611 and the first thermal fuse 613 may be separately formed or integrally formed with each other, to be disposed in the first heater 31. When the first plate temperature sensor 611 and the first thermal fuse 613 are integrally formed with each other, the first thermal fuse 613 having a relatively smaller size may be integrated in such a way as to be disposed inside of the first plate temperature sensor 611.

In FIGS. 9 to 12, the first plate temperature sensor 611 and the first thermal fuse 613 are separately formed, for example. Although embodiments are not limited thereto, the first plate temperature sensor 611 and the first thermal fuse 613 separately formed will be described as shown in the drawings as an embodiment.

As shown in the drawings, the first plate temperature sensor 611 may be configured to sense a temperature of an area of the cover plate 20, which is directly above the first heater 31. The first plate temperature sensor 611 may be a contact-type temperature sensor that may directly contact the bottom surface of the cover plate 20 to sense the temperature of the cover plate 20.

The first plate temperature sensor 611 coupled to an inner center area of the first holder 641 may be configured to sense the temperature of the bottom surface of the cover plate 20. The first plate temperature sensor 641 may be configured to directly contact the bottom surface of the cover plate 20 and sense the temperature of the cover plate 20. A sensing surface formed on an upper end of the first plate temperature sensor 611 may protrude further in the upward direction (U-direction) than the upper end of the first holder 641 to directly contact the bottom surface of the cover plate 20.

Each of the pair of the lead wires 6112 and 6113 provided in the first plate temperature sensor 611 may have one or a first end connected to a lower end of the first plate temperature sensor 611 and the other or a second end penetrating the cable holder 3112a of the edge wall 3112 to be electrically connected to the control circuit board module 80. A connector 615 may be connected between both ends of each lead wire to support the pair of lead wires of the first plate temperature sensor 611 and the pair of leads wires of the first thermal fuse 613, which will be described hereinafter.

The first coil temperature sensor 612 may be disposed on the bottom surface of the working coil 312 of the first heater 31 to sense the temperature of the working coil 312. The first coil temperature sensor 612 may be a contact-type temperature sensor configured to sense the temperature by contact with the bottom surface of the working coil 312, like the first plate temperature sensor 611.

As described above, the first coil temperature sensor 612 may be mounted on the sensor bracket formed in the through hole of the core frame. The first coil temperature sensor 612 may have a same exterior design and a same standard to be compatible with the first plate temperature sensor 611.

The first thermal fuse 613 may serve to sense whether the area of the cover plate 20 directly above the first heater 31 is overheated, and may include a non-contact type sensor disposed on the bottom surface of the cover plate 20. For example, the non-contact sensor may be a thermostat which is a well-known example in the art.

The first thermal fuse 613 may be held in the second holder 642, which will be described hereinafter. The first thermal fuse 613 may correspond to a safety device in which the circuit is open when the temperature of the cover plate 20 exceeds a predetermined threshold value and overheating occurs.

The first thermal fuse 613 may be classified into a recovery type that automatically returns to an original state when the temperature falls below a predetermined value after the circuit is open due to the occurrence of overheating, and a non-recovery type that does not return to the original state. The first thermal fuse 613 applied to this embodiment may be the recovery type.

Accordingly, when overheating occurs in the cover plate 20, an internal circuit of the first thermal fuse 613 may be open. When the temperature of the cover plate 20 falls below the temperature in the overheating state, the internal circuit may be automatically closed. The first thermal fuse 613 provided as the recovery type is already well-known in the art, and thus, detailed configuration thereof has been omitted.

Similar to the first plate temperature sensor 611, the pair of lead wires 6131 and 6132 provided in the first thermal fuse 613 may be electrically connected to the control circuit board module 80 after penetrating the cable holder 3112a formed in the edge wall 3112 of the core frame 311. As mentioned above, the pair of lead wire of lead wires provided in the first thermal fuse 613 may be connected to the connector 615 together with the pair of lead wires provided in the first plate temperature sensor 611.

The first sensor holder 614 may include a first holder 6141 formed in a substantially hollow cylindrical shape, and a second holder 6142 integrally formed with an upper end of the first holder 6141 in a box shape extending outward from an upper end of the first holder 6141.

The first holder 6141 may include a cylindrical portion 6141a defining an exterior thereof, and the first plate temperature sensor 611 may be secured in the cylindrical portion 6141a. A circular plate-shaped extension plate 6141b may be formed in the cylindrical portion 6141a, may extend from an inner circumferential surface of the cylindrical portion 6141a toward an inside of the cylindrical portion 6141a. A fitting hole 6141c may be formed in a center of the extension plate 6141b so that the first plate temperature sensor 611 may be fitted into the fitting hole 6141c. The first plate temperature sensor 611 may be fitted into the fitting hole 6141c from the upward direction (U-direction) toward the downward direction (D-direction), thereby being coupled to the first sensor holder 614.

When the cylindrical portion 6141a is divided in the vertical direction (U-D direction), a lower area may pass through the coupling hole 3111a of the core frame 311 described above and extend in the downward direction (D-direction). An upper area of the cylindrical portion 6141a may be coupled to the coupling hole 3111a in such a way of not passing through the coupling hole. The upper area of the cylindrical portion 6141a may have an outer diameter that is greater than an inner diameter of the coupling hole 3111a and a lower area thereof may have an outer diameter that is smaller than the inner diameter of the coupling hole 3111a.

A protrusion 6141d may be formed at a lowest point of the cylindrical portion 6141a to prevent separation of the cylindrical portion inserted in the coupling hole 3111a. As shown in the drawings, a guide groove 6141e may be formed in the protrusion 6141d so that the pair of the lead wires of the first thermal fuse 613 may pass through the guide groove 6141e. The guide groove 6141e may be formed by cutting-away some of the protrusion 6141d, for example.

The second holder 6142 may include a plate-shaped upper plate portion 6142a that extends radially (r-direction) outward from the cylindrical portion 6141a of the first holder 6141, and a fuse securing portion 6142c integrally formed with a lower surface of the upper plate portion 6142a.

As shown in the drawings, an exposure hole 6142b through which the first thermal fuse 613 is exposed may be formed in the upper plate portion 6142a that extends from an upper end of the cylindrical portion 6141a. A size of the exposure hole 6142b may be determined enough to expose the sensing surface of the first thermal fuse 613 at least partially.

The fuse securing portion 6142c integrally formed with the upper plate portion 6142a may be provided at a lower surface of the upper plate portion 6142a. Like the upper plate portion 6142a, the fuse securing portion 6142c may be formed in a box shape, for example, that extends radially outward from the cylindrical portion 6141a of the first holder 6141.

A fuse insertion groove 6142d may be formed in the fuse securing portion 6142c so that the first thermal fuse 613 may be insertedly secured to the fuse insertion groove 6142d. For example, the fuse insertion groove 6142d may be formed by recessing some of the fuse securing portion 6142c in the upward direction (U-direction), and may have a size sufficient to accommodate an entire area of the first thermal fuse 613. Notched grooves 6142e, through which the lead wires of the first thermal fuse 613 may pass, may be formed in both lateral surfaces of the fuse insertion groove 6142d, respectively.

The first plate temperature sensor 611 and the first thermal fuse 613 of the first temperature sensor 61 of the electric range 1 as mentioned above may be connected to each other in series. Although not shown, when they are integrally manufactured, the first plate temperature sensor 611 and the first thermal fuse 613 may be connected in series to achieve a series connection structure. However, when separately manufactured, a separate means for connecting the first plate temperature sensor 611 and the first thermal fuse 613 in series may be required. For example, the separate means for serial connection may be provided in the connector 615 described above. More specifically, the separate means may be achieved through a relay terminal provided in the connector 615.

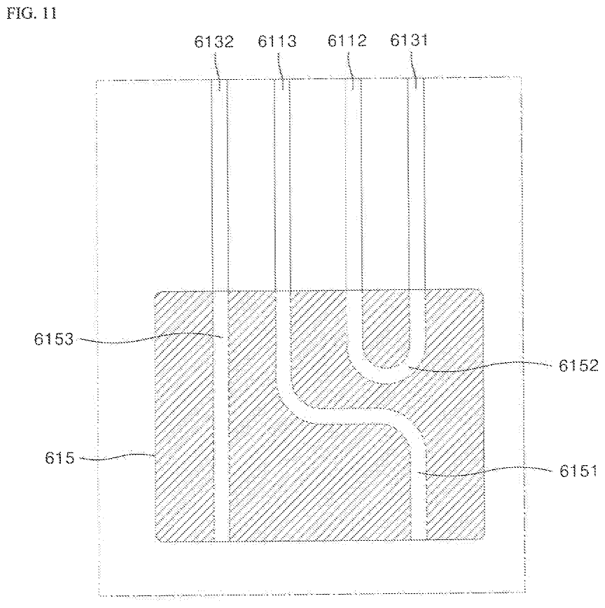

FIGS. 11 and 12 are schematic views showing that the first plate temperature sensor 611 and the first thermal fuse 613 are connected in series through a relay terminal inside of the connector 615. As shown in FIG. 11, an input relay terminal 6151, an intermediate relay terminal 6152, and an output relay terminal 6153 may be provided in the connector 615.

The input relay terminal 6151 of the connector 615 may be electrically connected to the first lead wire 6131 of the first thermal fuse 613. The second lead wire 6132 of the first thermal fuse 613 may be electrically connected to one or a first end of the intermediate terminal 6152, and the other or a second end thereof may be electrically connected to the first lead wire of the first plate temperature sensor 611. The second lead wire of the first plate temperature sensor 611 may be electrically connected to the output relay terminal 6153.

The input relay terminal 6151 and the output relay terminal 6153 of the connector 615 may be connected to the controller 100, which will be described hereinafter through an input lead wire and an output lead wire (not shown). In addition, a first temperature sensing circuit (TC1, see FIG. 13) connected to the first plate temperature sensor 611 and the first thermal fuse 613 in series may be formed.

With this structure, the first thermal fuse 613 may be connected in series to the first lead wire 6112 corresponding to an input end of the first plate temperature sensor 611, and the first temperature sensor 611 may be connected in series, thereby forming the first temperature sensing circuit (TC1, see FIG. 13) in which the first plate temperature sensor 611 and the first thermal fuse 613 are connected in series. Alternatively, as shown in FIG. 12, the first thermal fuse 613 may be serially connected to the second lead wire 6113 corresponding to an output end of the first plate temperature sensor 611. The input relay terminal 6151 of the connector 615 may be electrically connected to the first lead wire 6112 of the first plate temperature sensor 611.

The first lead wire 6112 of the first plate temperature sensor 611 may be electrically connected to one or a first end of the intermediate relay terminal 6152, and the other or a second end thereof may be electrically connected to the second lead wire of the first thermal fuse 613. Finally, the first lead wire 6131 of the first thermal fuse 613 may be electrically connected to the output relay terminal 6153. The first temperature sensing circuit (TC1, see FIG. 13) in which the above-mentioned elements are connected in serial may be formed.

The input relay terminal 6151 and the output relay terminal 6153 of the connector 615 may be connected to the controller 100, which will be described hereinafter, through the input lead wire and the output lead wire (not shown). Accordingly, the first temperature sensing circuit (TC1, see FIG. 13) in which the first plate temperature sensor 611 and the first thermal fuse 613 are connected in series may be formed.

In FIGS. 11 and 12, the separate means for serial connection of the first plate temperature sensor 611 and the first thermal fuse 613 are described as the relay terminals provided inside the connector 615. However, they are only exemplary. Modifications in which the series connection structure can be achieved through means other than the connector 615 may be also applicable, of course, and it will be understood that they are included within the scope of the present disclosure.

Although not shown in the drawings, a temperature sensing circuit TC2 including a second plate temperature sensor 621 and the second thermal fuse 623, and a third temperature sensing circuit TC3 including a third plate temperature sensor 631 and a third thermal fuse 633 may have the same configuration as the first temperature sensing circuit TC3.

Hereinafter, a controller according to an embodiment of the electric range 1 will be described referring to FIG. 13.

As shown in FIG. 13, the electric range 1 according to an embodiment may include a controller 100 configured to control each functional configuration. The controller 100 may be mounted on the above-described control circuit board module 80, more particularly, the main circuit board module 81 together with the power conversion module, for example, the switching element 812. As well known in the art, the controller may be provided in various formats, for example, such as a microcontroller, a microcontroller, or a microprocessor, for example.

As shown in the drawings, the controller 100 may be electrically connected to the power circuit board module 83. Power input from the external power source may be converted through the power circuit board module 83 and supplied to the controller 100 and the switching element 812. The power supplied to the switching element 812 may be converted into high-frequency power and transmitted to the working coil 312 of the first heater 31, the working coil 322 of the second heater 32 and the working coil 322 of the third heater 33 based on a control signal of the controller 100.

Also, the controller 100 may be individually connected to the first temperature sensing circuit TC1, the second temperature sensing circuit TC2, and the third temperature sensing circuit TC3. Temperatures and overheating of the first to third heaters 31 to 33 may be independently monitored by the first temperature sensing circuit TC1, the second temperature sensing circuit TC2, and the third temperature sensing circuit TC3, which are individually connected.

In particular, as described above, the first temperature sensing circuit TC1, the second temperature sensing circuit TC2, and the third temperature sensing circuit TC3 of the electric range 1 according to an embodiment may be provided in a state in which the plate temperature sensor and the thermal fuse are connected in series. Accordingly, if the temperature sensing circuit is opened by a disconnection occurring inside the thermal fuses 613, 623, and 633 due to overheating of any one of the first to third heaters 31 to 33, the controller 100 may detect the circuit opening and immediately detect that the corresponding heater is in an overheated state.

Hence, when it determines that the heater is in the overheated state, the controller 100 may be implemented to stop operation of the switching element 812 so as to stop supplying power to the corresponding heater. However, as described above, the first to third thermal fuses 613, 623, and 633 provided in each temperature sensing circuit may be return type fuses. When the temperature falls below a predetermined temperature after the circuit is opened, the thermal fuses may automatically return to the original state and the opened temperature sensing circuit may be restored to the closed state.

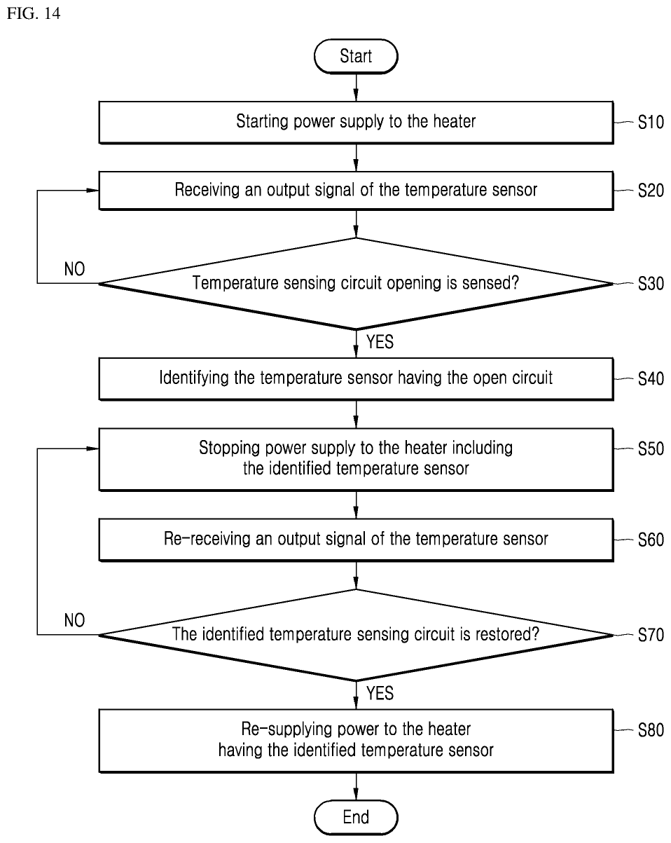

Hereinafter, referring to FIG. 14, a method for controlling an electric range according to an embodiment will be described. The method may be practiced using embodiments of an electric range discussed above.

As described above, embodiments disclosed herein remarkably improve user convenience by automatically stopping operation of heater when overheating occurs and automatically and re-operating it when the overheated state is resolved. This may be achieved by the method discussed hereinafter.

Referring to FIG. 14, the controller 100 may transmit a control signal to the switching element 812 to start heating of a heating target, and start power supply to the first to third heaters 31 to 33 (S10). At this time, power may be supplied to some of the first to third heaters 31 to 33 to use some of the first to third heaters 31 to 33 based on user's selection.

Hereinafter, for convenience, a case in which power is simultaneously supplied to the first and second heaters 31 and 32 will be focused on so that the method for controlling the electric range 1 according to an embodiment may be understood in a more diverse way.

When power supply to the working coil 312 of the first heater 31 and the working coil 322 of the second heater 32 starts (S10), the controller may receive an output signal of the first temperature sensor 61 and an output signal of the second temperature sensor 62 (S20). The output signal of the first temperature sensor 61 may be independently received through the first temperature sensing circuit TC1 and the output signal of the second temperature sensor 62 through the second temperature sensing circuit TC2. The output signal of the first temperature sensor 61 may relate to the temperature of the first heater 31 and the output signal of the second temperature sensor 62 may relate to the temperature of the second temperature sensor 62, as the first thermal fuse 613 is serially connected to the first plate temperature sensor 611 and the second thermal fuse 623 is serially connected to the second plate temperature sensor 621.

When the output signal of the first temperature sensor 61 and the output signal of the second temperature sensor 62 are received (S20), the controller 100 may determine whether the first temperature sensing circuit TC1 and the second temperature sensing circuit TC2 are open based on the output signals (S30). When the received output signals of the first temperature sensor 61 and the second temperature sensor 62 are out of a range of normal signal values output when they are normally connected, it may be determined that the output signals are not received.

Such an abnormal signal may be generated when the inner circuit is opened in the first thermal fuse 613 or the second thermal fuse 623 due to overheating occurring in the first heater 31 or the second heater 32. Accordingly, the controller 100 may determine that the first heater 31 or the second heater 32 is in the overheated state once receiving the abnormal signal.

When having determined that the first temperature sensing circuit TC1 or the second temperature sensing circuit TC2 is opened (S30), the controller 100 may identify that the temperature sensing circuit outputting the abnormal signal is opened (S40). For example, description will be made based on a case in which only the first temperature sensing circuit TC1 is detected in an open state.

When identifying that the first temperature sensing circuit TC1 is opened, the controller 100 may transmit a control signal configured to stop operation of the switching element 812 to the switching element 812. Hence, the switching element 812 may be stopped from supplying power to the working coil 312 of the first heater 31 and the working coil 322 of the second heater 32 (S50). The reason that the power supply to the second heater 32 in which overheating does not occur is also stopped is because the operation of the entire switching elements 812 is stopped as described above.

When the power supply to the first heater 31 and the second heater 32 is stopped (S50), the controller 100 may re-receive the output signal of the first temperature sensing circuit TC1 and the output signal of the second temperature sensing circuit TC2 (S70). When re-receiving the output signal of the first temperature sensing circuit TC1 and the output signal of the second temperature sensing circuit TC2 (S70), the controller 100 may determine whether the open first temperature sensing circuit TC1 returned to the original state (S80).

As mentioned above, the first thermal fuse 613 is the return type fuse. When the temperature of the first heater 31 falls below a predetermined temperature after the internal circuit of the first thermal fuse 613 is opened, the first thermal fuse 613 may be automatically restored to its original state. The controller 100 may check whether the first thermal fuse 613 has returned to the original state as described to identify whether the first temperature sensing circuit TC1 returns to the original state.

Once determining that the first temperature sensing circuit TC1 is not restored to the original state (S80), the controller 100 may return to S50 and repeat the subsequent operations. However, when determining that the first temperature sensing circuit TC1 is restored to the original state (S80), the controller 100 may transmit a control signal to the switching element 812 to control power to be re-supplied to the working coil 312 of the first heater 31 and the working coil 322 of the second heater 32 (S90). As the current overheated state of the first heater 31 has been resolved, power supply to the first heater 31 and the second heater 32 may re-start to resume the cooking process that was interrupted due to the overheating.

Embodiments disclosed herein provide an electric range an electric range that may simplify a configuration of a temperature sensing circuit and a configuration of a control board electrically connected to the temperature sensing circuit by connecting in series a thermal fuse that senses overheat of a cover plate to a plate temperature sensor that senses a temperature of the cover plate, thereby reducing manufacturing costs, and a method for controlling an electric range. Embodiments disclosed herein also provide an electric range that may restore an original state when an overheating condition is resolved by applying a return type thermal fuse and may automatically resume an operation of a stopped heating portion by detecting a recovery state.

Advantages are not limited to the above advantages, and other advantages that are not mentioned above can be clearly understood from the description and can be more clearly understood from the embodiments set forth herein.

An electric range according to embodiments disclosed herein is provided that may include a cover plate on which a heating target is disposed; a heating portion or heater comprising a working coil to which high-frequency power is applied and configured to heat the heating target by using a magnetic field generated from the working coil; a plate temperature sensor disposed in the heating portion and configured to sense a temperature of the cover plate; a thermal fuse disposed in the heating portion and configured to sense overheating of the cover plate; and a controller configured to supply electric power to the working coil and having the plate temperature sensor and the thermal fuse electrically connected thereto. The plate temperature sensor and the thermal fuse may be connected to each other in series, and connected to the controller to form a temperature sensing circuit. When overheating occurs in the cover plate, the temperature sensing circuit may be opened by the thermal fuse and the controller may be implemented to stop power supply to the working coil.

The plate temperature sensor and the thermal fuse may be separately formed and disposed in the heating portion. The plate temperature sensor and the thermal fuse may be integrally formed with each other and disposed in the heating portion.

The heating portion may include a first heating portion or heater and a second heating portion or heater that are spaced a preset or predetermined distance apart from each other. The plate temperature sensor may include a first plate temperature sensor disposed in the first heating portion, and a second plate temperature sensor disposed in the second heating portion. The thermal fuse may include a first thermal fuse disposed in the first heating portion, and a second thermal fuse disposed in the second heating portion.

The temperature sensing circuit may include a first temperature sensing circuit formed by being connected to the first plate temperature sensor and the first thermal fuse in series and connected to the controller; and a second temperature sensing circuit formed by being connected to the second plate temperature sensor and the second thermal fuse in series and connected to the controller. When sensing overheating, the first thermal fuse may open the first temperature sensing circuit, and when the overheating is resolved, the first thermal fuse may restore the first temperature sensing circuit to its original closed state. When sensing overheating, the second thermal fuse may open the second temperature sensing circuit, and when the overheating is resolved, the second thermal fuse may restore the second temperature sensing circuit to its original closed state,

When power supply to the first heating portion and the second heating portion starts, the controller may separately receive an output signal from the first temperature sensing circuit and an output signal from the second temperature sensing circuit. The controller determines whether the first temperature and the second temperature sensing circuit are opened based on the received output signals.

Once determining that the first temperature sensing circuit is opened among the first and second temperature sensing circuit, the controller may stop power supply to the working coil of the first heating portion and the working coil of the second heating portion. After stopping the power supply to the first heating portion, the controller may re-receive an output signal from the first temperature sensing circuit and an output signal from the second temperature sensing circuit, and determine whether the first temperature sensing circuit is restored to the original closed state based on the re-received output signals. Once identifying that the first temperature sensing circuit is restored to the closed state, the controller may restart power supply to the working coil of the first heating portion and the working coil of the second heating portion.

In a method for controlling an electric range according to embodiments disclosed herein, the electric range may include a cover plate on which a heating target is disposed; a heating portion or heater comprising a working coil to which high-frequency power is applied and configured to heat the heating target using a magnetic field generated from the working coil; a plate temperature sensor disposed in the heating portion and configured to sense a temperature of the cover plate; a thermal fuse disposed in the heating portion and configured to sense overheating of the cover plate; and a controller configured to supply electric power to the working coil and having the plate temperature sensor and the thermal fuse electrically connected thereto. The plate temperature sensor and the thermal fuse may be connected to each other in series, and connected to the controller to form a temperature sensing circuit. In the method, the temperature sensing circuit may be opened by the thermal fuse and the controller may be implemented to stop power supply to the working coil, when overheating occurs in the cover plate.

The plate temperature sensor and the thermal fuse may be separately formed and disposed in the heating portion. The plate temperature sensor and the thermal fuse may be integrally formed with each other and disposed in the heating portion.

The heating portion may include a first heating portion or heater and a second heating portion or heater that are spaced a preset or predetermined distance apart from each other. The plate temperature sensor may include a first plate temperature sensor disposed in the first heating portion, and a second plate temperature sensor disposed in the second heating portion. The thermal fuse may include a first thermal fuse disposed in the first heating portion, and a second thermal fuse disposed in the second heating portion.

The temperature sensing circuit may include a first temperature sensing circuit formed by being connected to the first plate temperature sensor and the first thermal fuse in series and connected to the controller, and a second temperature sensing circuit formed by being connected to the second plate temperature sensor and the second thermal fuse in series and connected to the controller. When sensing overheating, the first thermal fuse may open the first temperature sensing circuit, and when the overheating is resolved, the first thermal fuse may restore the first temperature sensing circuit to its original closed state. When sensing overheating, the second thermal fuse may open the second temperature sensing circuit, and when the overheating is resolved, the second thermal fuse may restore the second temperature sensing circuit to its original closed state.

The method may include an output signal receiving operation configured to separately receive an output signal from the first temperature sensing circuit and an output signal from the second temperature sensing circuit when power supply to the first heating portion and the second heating portion starts, and a circuit opening determining operation configured to determine whether the first temperature sensing circuit and the second temperature sensing circuit are open based on the output signals received in the output signal receiving operation. The method may further include a power supply stopping operation configured to the stop power supply to the working coil of the first heating portion and the working coil of the second heating portion, once it is determined in the circuit opening determining operation that the first temperature sensing circuit is opened among the first and second temperature sensing circuit.

The method may include an output signal re-receiving operation configured to separately re-receive an output signal from the first temperature sensing circuit and an output signal from the second temperature sensing circuit, after the power supply to the first heating portion is stopped in the power supply stopping operation, and a circuit restoring determining operation configured to determine whether the first temperature sensing circuit is restored to its original closed state based on the output signals re-received in the output signal re-receiving operation. The method may further include a power re-supplying operation configured to re-start power supply to the working coil of the first heating portion and the working coil of the second heating portion, when it is identified in the circuit restoring determination operation that the first temperature sensing circuit is restored to the original closed state.

Embodiments disclosed herein may have at least the following advantages. According to embodiments disclosed herein, the plate temperature sensor configured to sense the temperature of a cover plate and the thermal fuse configured to sense overheating of the cover plate may be connected in series to configurate a temperature sensing circuit, thereby simplifying a control substrate to which the temperature sensing circuit is electrically connected and reducing manufacture costs. Further, the return type thermal fuse may be applied to restore the original state when the overheating is resolved, and operation of the heating portion may automatically restart by detecting the restored state, thereby improving user convenience.

Embodiments are described above with reference to a number of illustrative embodiments thereof. However, the embodiments are not intended to be limited to the embodiments and drawings set forth herein, and numerous other modifications and embodiments can be devised by one skilled in the art. Further, the effects and predictable effects based on the configurations are to be included within the range of the disclosure though not explicitly described in the description of the embodiments.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower” and “upper”, for example, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric range, comprising:
a cover plate on which a heating target is disposed;
a heater comprising a working coil to which high-frequency power is applied and configured to heat the heating target using a magnetic field generated from the working coil;
a plate temperature sensor disposed in the heater and configured to sense a temperature of the cover plate;
a thermal fuse disposed in the heater and configured to sense overheating of the cover plate; and
a controller configured to supply electric power to the working coil and having the plate temperature sensor and the thermal fuse electrically connected thereto, wherein the plate temperature sensor and the thermal fuse are connected to each other in series and connected to the controller to form a temperature sensing circuit, and when overheating occurs in the cover plate, the temperature sensing circuit is opened by the thermal fuse and the controller stops power supply to the working coil.

2. The electric range of claim 1, wherein the plate temperature sensor and the thermal fuse are separately formed and disposed in the heater.

3. The electric range of claim 1, wherein the plate temperature sensor and the thermal fuse are integrally formed with each other and disposed in the heater.

4. The electric range of claim 1, wherein the heater comprises a first heater and a second heater spaced a predetermined distance apart from each other, wherein the plate temperature sensor comprises a first plate temperature sensor disposed in the first heater and a second plate temperature sensor disposed in the second heater, and wherein the thermal fuse comprises a first thermal fuse disposed in the first heater and a second thermal fuse disposed in the second heater.

5. The electric range of claim 4, wherein the temperature sensing circuit comprises:
a first temperature sensing circuit connected to the first plate temperature sensor and the first thermal fuse in series and connected to the controller; and
a second temperature sensing circuit connected to the second plate temperature sensor and the second thermal fuse in series and connected to the controller.

6. The electric range of claim 5, wherein when sensing overheating, the first thermal fuse opens the first temperature sensing circuit, and when the overheating is resolved, the first thermal fuse restores the first temperature sensing circuit to its original closed state, and when sensing overheating, the second thermal fuse opens the second temperature sensing circuit, and when the overheating is resolved, the second thermal fuse restores the second temperature sensing circuit to an original closed state.

7. The electric range of claim 4, wherein when power supply to the first heater and the second heater starts, the controller separately receives an output signal from the first temperature sensing circuit and an output signal from the second temperature sensing circuit, and wherein the controller determines whether the first temperature sensing circuit and the second temperature sensing circuit are open based on the received output signals.

8. The electric range of claim 7, wherein once determining that the first temperature sensing circuit is open among the first and second temperature sensing circuits, the controller stops power supply to the working coil of the first heater and the working coil of the second heater.

9. The electric range of claim 8, wherein after stopping the power supply to the first heater, the controller re-receives an output signal from the first temperature sensing circuit and an output signal from the second temperature sensing circuit, and determines whether the first temperature sensing circuit is restored to the original closed state based on the re-received output signals.

10. The electric range of claim 9, wherein once identifying that the first temperature sensing circuit is restored to the closed state, the controller restarts power supply to the working coil of the first heater and the working coil of the second heater.

11. A method for controlling an electric range, the electric range comprising a cover plate on which a heating target is disposed; a heater comprising a working coil to which high-frequency power is applied and configured to heat the heating target using a magnetic field generated from the working coil; a plate temperature sensor disposed in the heater and configured to sense a temperature of the cover plate; a thermal fuse disposed in the heater and configured to sense overheating of the cover plate; and a controller configured to supply electric power to the working coil and having the plate temperature sensor and the thermal fuse electrically connected thereto, wherein the plate temperature sensor and the thermal fuse are connected to each other in series and connected to the controller to form a temperature sensing circuit, the method comprising:
sensing overheating of the cover plate via the thermal fuse; and
when overheating occurs in the cover plate, opening the temperature sensing circuit via the thermal fuse and stopping power supply to the working coil via the controller.

12. The method for controlling the electric range of claim 11, wherein the plate temperature sensor and the thermal fuse are separately formed and disposed in the heater.

13. The method for controlling the electric range of claim 11, wherein the plate temperature sensor and the thermal fuse are integrally formed and disposed in the heater.

14. The method for controlling the electric range of claim 11, wherein the heater comprises a first heater and a second heater spaced a predetermined distance apart from each other, wherein the plate temperature sensor comprises a first plate temperature sensor disposed in the first heater and a second plate temperature sensor disposed in the second heater, and wherein the thermal fuse comprises a first thermal fuse disposed in the first heater and a second thermal fuse disposed in the second heater.

15. The method for controlling the electric range of claim 14, wherein the temperature sensing circuit comprises a first temperature sensing circuit formed by the first plate temperature sensor and the first thermal fuse which are connected in series and connected to the controller; and
a second temperature sensing circuit formed by the second plate temperature sensor and the second thermal fuse which are connected in series and connected to the controller.

16. The method for controlling the electric range of claim 15, wherein the opening the temperature sensing circuit via the thermal fuse and stopping power supply to the working coil via the controller when the overheating occurs in the cover plate comprises:
opening the first temperature sensing circuit via the first thermal fuse, and when the overheating is resolved, restoring the first temperature sensing circuit to an original closed state; and
opening the second temperature sensing circuit via the second thermal fuse when sensing overheating, and when the overheating is resolved, restoring the second temperature sensing circuit to an original closed state via the second thermal fuse.

17. The method for controlling the electric range of claim 16, further comprising:
separately receiving via the controller an output signal from the first temperature sensing circuit and an output signal from the second temperature sensing circuit when power supply to the first heater and the second heater starts; and
determining whether the first temperature sensing circuit and the second temperature sensing circuit are opened based on the output signals received by the controller.

18. The method for controlling the electric range of claim 17, further comprising:
stopping via the controller power supply to the working coil of the first heater and the working coil of the second heater, once it is determined that the first temperature sensing circuit is open among the first and second temperature sensing circuit.

19. The method for controlling the electric range of claim 18, further comprising:
separately re-receiving via the controller an output signal from the first temperature sensing circuit and an output signal from the second temperature sensing circuit, after the power supply to the first heater is stopped; and
determining whether the first temperature sensing circuit is restored to an original closed state based on the output signals re-received by the controller.

20. The method for controlling the electric range of claim 19, further comprising:
re-starting via the controller power supply to the working coil of the first heater and the working coil of the second heater, when it is determined that the first temperature sensing circuit is restored to the original closed state.
